(19) United States
(12) Patent Application Publication
(10) Pub. No.: US 2016/0049125 A1
(43) Pub. Date: Feb. 18, 2016

(54) METHOD FOR DRIVING A HSD LIQUID CRYSTAL DISPLAY PANEL AND DISPLAY DEVICE

(71) Applicant: SHENZHEN CHINA STAR OPTOELECTRONICS TECHNOLOGY CO., LTD., Shenzhen, Guangdong (CN)

(72) Inventor: Xiaohui YAO, Shenzhen (CN)

(21) Appl. No.: 14/417,383

(22) PCT Filed: Jul. 29, 2014
(86) PCT No.: PCT/CN2014/083236

§ 371 Date: Jan. 26, 2015

(30) Foreign Application Priority Data
Jul. 4, 2014 (CN) 201410317749.9

(51) Int. Cl. G09G 3/36

(52) U.S. Cl. CPC G09G 3/3614; G09G 3/3648; G09G 3/3696; G09G 3/3685; G09G 2300/0426; G09G 2330/027

(57) ABSTRACT

The present disclosure discloses a method for driving a HSD liquid crystal display panel, comprising: providing a sequence of scanning pulse signals to gate lines of said liquid crystal display panel to turn on a TFT elements corresponding to each row of pixel units respectively; and providing a square wave data signals to data lines of said liquid crystal display panel to charge pixel units connected with a drains of said TFT elements, wherein the polarity of said square wave data signals reverses once after every 2n+1 scanning pulses, in which n is integer larger than or equal to 1. The present disclosure also provides a device for implementing the method, comprising a liquid crystal display unit, a scanning driving unit, a data signals driving unit and a timing control unit. The present disclosure enables the pixel units with different brightness in the two sides of data lines appear besides said data lines in a staggered way, and the pixel units with different brightness are located in a staggered way in space, thereby the display effect of bright-dark lines in vertical direction of a display panel being improved.

### CROSS REFERENCE TO RELATED APPLICATION

The present application claims benefit of Chinese patent application CN 201410317749.9, entitled “Method for Driving a HSD Liquid Crystal Display Panel and Display Device” and filed on Jul. 4, 2014, which is incorporated herein by reference.

### FIELD OF THE INVENTION

The present disclosure relates to the technical field of liquid crystal display, particularly to a method for driving the display to improve the display effect of a liquid crystal display panel with Half Source Driving (HSD) structure and HSD liquid crystal display device.

### BACKGROUND OF THE INVENTION

The left-right adjacent pixel units of HSD pixel array share the same data line, thus compared with the traditional array for driving the liquid crystal pixel, the number of data lines is halved. The adjacent pixel units in the same row are connected with different scanning lines, and the upper-lower adjacent pixel units are connected with different scanning lines, thus compared with the traditional array for driving the liquid crystal pixel, the number of scanning lines is doubled. The number of pixel units connected to each scanning line reduces, and the scanning pulse time allocated to each scanning line reduces accordingly, so that the charging time of pixel units is reduced. Under the circumstances, the difference of charging rate of pixel units caused by signal delay becomes significant. For example, in a liquid crystal display panel with the HSD structure, as the time sequences for driving pixel units besides data lines are different, the difference of charging rate of pixel units besides the same row of date lines will be generated due to the delay effect on the date lines, which results in the display defect of bright-dark lines in vertical direction.

Based on the above situations, a method for improving the display effect of bright-dark lines in vertical direction of a HSD liquid crystal display panel is needed.

### SUMMARY OF THE INVENTION

To solve the aforesaid problems, the present disclosure provides a method for improving the display effect of bright-dark lines in vertical direction of a HSD liquid crystal display panel.

According to one aspect of the present disclosure, the present disclosure provides a method for driving a HSD liquid crystal display panel, comprising the steps of:

providing a sequence of scanning pulse signals to gate lines of said liquid crystal display panel to turn on TFT elements corresponding to each row of pixel units respectively; and

providing square wave data signals to data lines of said liquid crystal display panel to charge pixel units connected with drains of said TFT elements through said square wave data signals when said TFT elements are turned on, wherein the polarity of said square wave data signal is reversed once every 2n+1 scanning pulses, in which n is integer larger than or equal to 1.

According to one embodiment, the polarity of said square wave data signal is controlled through a first polarity reversing signal provided by a timing control unit, and is reversed once every three scanning pulses.

According to one embodiment, the on/off state of said TFT elements of pixel units in even-numbered columns are controlled by odd-numbered gate lines, and the on/off state of said TFT elements of pixel units in odd-numbered columns are controlled by even-numbered gate lines.

According to one embodiment, a second polarity reversing signal is provided by the timing control unit so that the polarity of said square wave data signals of data lines corresponding to pixels in odd-numbered columns is opposite to the polarity of said square wave data signals of data lines corresponding to pixels in even-numbered columns at the same time.

According to another aspect of the present disclosure, the present disclosure also provides a HSD liquid crystal display device, comprising:

a liquid crystal display unit comprising a plurality pairs of gate lines and a plurality of data lines, wherein two pixel units are provided in the space surrounded by adjacent pairs of gate lines and adjacent date lines, and said data lines are connected with sources of TFT elements of pixel units in two adjacent columns respectively;

a scanning signal driving unit for providing sequence scanning pulse signals to said gate lines, thus turning on said TFT elements corresponding to each row of pixel units; and

a data signal driving unit for providing a square wave data signals to said data lines, thus charging pixel units connected with drains of said TFT elements by said square wave data signals when said TFT elements are turned on, wherein the polarity of said square wave data signal is reversed once every 2n+1 scanning pulses, in which n is integer larger than or equal to 1.

According to one embodiment, said device further comprises a timing control unit for proving a first polarity reversing signal to said data signal driving unit, so that the polarity of said square wave data signal is reversed once every three scanning cycles.

According to one embodiment, a second polarity reversing signal is provided by the timing control unit so that the polarity of said square wave data signals of data lines corresponding to pixels in odd-numbered columns is opposite to the polarity of said square wave data signals of data lines corresponding to pixels in even-numbered columns at the same time.

According to one embodiment, the gate lines of said device are arranged as follows: the on/off state of said TFT elements of pixel units in even-numbered columns are controlled by odd-numbered gate lines, and the on/off state of said TFT elements of pixel units in odd-numbered columns are controlled by even-numbered gate lines.

The following beneficial effects are achieved by the present disclosure.

By setting the polarity of said square wave data signal to reverse once after every 2n+1 scanning pulses, n being integer larger than or equal to 1, i.e., setting the polarity of said square wave data signal to reverse once after odd number of scanning pulses, the present disclosure enables the pixel units besides data lines with different brightness appear in a staggered way at the two sides of said data lines. Since the pixel units with different brightness are located in a staggered way in space, the display effect of bright-dark lines in vertical direction of a display panel is improved.

Other features and advantages of the present disclosure will be stated hereinafter, and part of them will become obvious in the description or become understandable through the embodiments of the present disclosure. The objectives and other advantages of the present disclosure can be achieved and obtained through the structures specified in the description, claims and drawings.

### BRIEF DESCRIPTION OF THE DRAWINGS

The accompanying drawings used in the explanations of the embodiments or the prior art are illustrated to further illustrate the technical solutions in the embodiments of the present disclosure or in the prior art more clearly.

FIG. 1 is a schematic diagram of a liquid crystal panel in which polarity of the square wave data signal is reversed once after every two scanning cycles;

FIG. 2 is a timing diagram of actual square wave data signals and corresponding scanning pulses of the panel in FIG. 1;

FIG. 3 is a schematic diagram of bright-dark display effect of the panel in FIG. 1;

FIG. 4 is a flow chart of a method of according to one embodiment the present disclosure;

FIG. 5 is a timing diagram of a waveform of actual square wave data signals when their polarities are reversed once after every three scanning cycles selected according to the present disclosure, and corresponding scanning pulses;

FIG. 6 is a schematic diagram of a liquid crystal panel when the polarity of said square wave data signal is reversed once after every three scanning cycles according to the method of FIG. 4;

FIG. 7 is a bright-dark display effect diagram corresponding to the embodiment as shown in FIG. 5; and

FIG. 8 is a structural diagram of a HSD liquid crystal display device for accomplishing the present method.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that as long as there is no structural conflict, all the technical features mentioned in all the embodiments may be combined together in any manner, and the technical solutions obtained in this manner all fall within the scope of the present disclosure.

Many specific details are elaborated hereinafter for providing a thorough understanding of the embodiments of the present disclosure. However, it is obvious for a person skilled in the art that, the present disclosure can be implemented without the details or specifics described herein.

In addition, the steps as shown in the process diagram can be executed in a computer system by a group of computer executable instructions. Although the logical sequence is shown in the process diagram, the steps shown or described herein can be executed in other sequences different from the one shown herein in some cases.

In a Thin Film Transistor-Liquid Crystal Display (TFT-LCD) panel, the pixel units of the display panel are controlled through controlling the gate lines by a scanning driving unit and controlling the data lines by a data driving unit. To interpret the improvements of the present disclosure more clearly, the polarity of the square wave data signal being reversed once after every two scanning pulses is taken as an example to interpret the principle of bright-dark lines in vertical direction appeared in a TFT-LCD display panel.

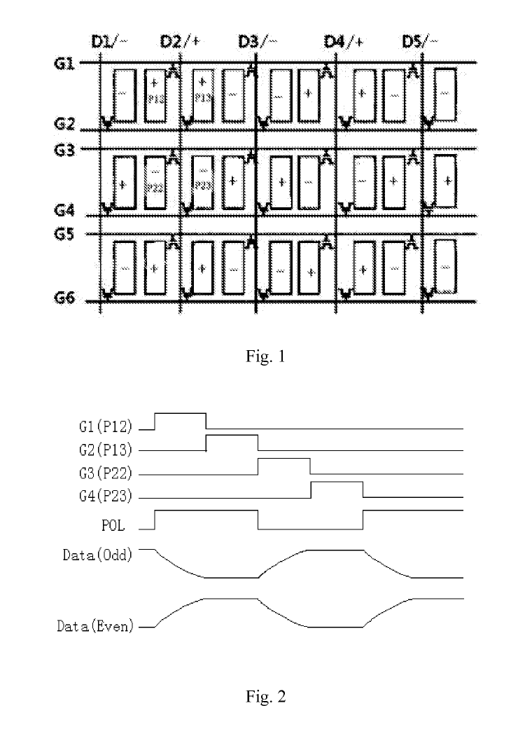

FIG. 1 is a schematic diagram of a pixel array of a TFT-LCD display panel with a HSD structure. The rows marked by G are scanning lines and the columns marked by D are data lines. The regions surrounded by scanning lines and data lines are pixel regions. As shown in FIG. 1, Pxy represents the pixel units, wherein x represents row x and y represents column y. For the same row of pixel units, the driving sequence of the scanning pulses in such that the pixel units besides one side of date lines in even columns are driven first, and the pixel units besides another side of date lines in odd columns are driven later. The reversed polarity of the square wave data signals of data lines is as shown in FIG. 1, indicated with signs “+” and “−”.

Due to the delay of signals appeared on the data lines, when the polarity of the square wave data signal of corresponding data line will be reversed, the data signals can only reach a stable value after a changing process. Take the data line D2 as an example, the pixel units P12, P13, P22, and P23 besides the two sides of D2 are driven sequentially. The waveform of actual square wave data signals and corresponding scanning pulses are shown in FIG. 2, in which POL is the polarity reversing control signals for reversing the polarity of the square wave data signals.

As shown in FIG. 2, when a scanning pulse of G1 arrives, since the voltage of the square wave data signal on D2 does not reach a designated voltage, the even column of pixel unit P12 corresponding to D2 cannot be charged completely during the scanning pulse of G1. When a scanning pulse of G2 arrives, since the voltage of the square wave data signal of D2 reaches the designated voltage, and the odd column of pixel unit P13 corresponding to D2 can be charged completely during the scanning pulse of G2. As a result, the brightness of the pixel unit P12 is lower than the pixel unit P13.

Then, the polarity of the square wave data signal on D2 is reversed and the driving sequence of scanning lines does not change. When a scanning pulse of G3 arrives, since the voltage of the square wave data signal of D2 does not reach a designated voltage, the even column of pixel unit P22 corresponding to D2 cannot be charged completely during the scanning pulse of G3. When a scanning pulse of G4 arrives, since the voltage of the square wave data signal of D2 reaches the designated voltage, and the odd column of pixel unit P23 corresponding to D2 can be charged completely during the scanning pulse of G4. As a result, the brightness of the pixel unit P22 is lower than the pixel unit P23.

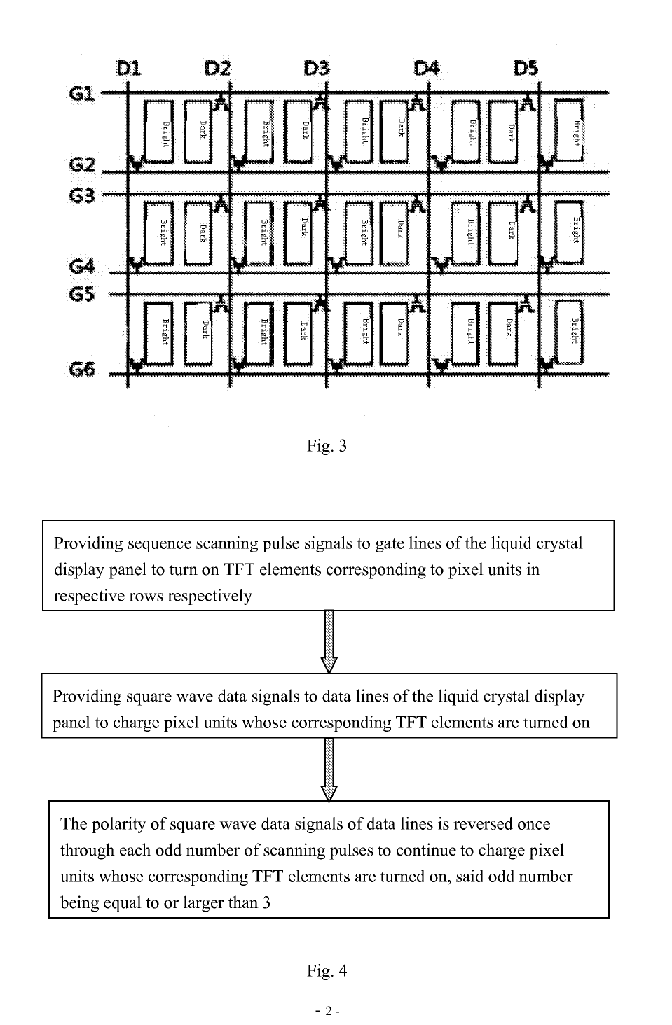

Therefore, the brightness of the pixel units P12 and P22 in even column is generally lower than the brightness of the pixel units P13 and P23 in odd column. For other pixel units of even and odd columns beside the two sides of D2, on the condition that the driving sequence of the scanning lines does not change, all pixel units in even column are undercharged. In consequence, the pixel units in even and odd columns generally appear bright-dark lines in vertical direction. With respect to other data lines, the same display defect also exists, as shown in FIG. 3. As a result, the whole liquid crystal display panel will display a picture in which vertical bright lines and vertical dark lines appear alternately.

To improve the display effect of bright-dark lines in vertical direction according to the aforesaid driving method, the present disclosure provides an improved driving method for a HSD liquid crystal display panel.

The steps of the present method are shown in FIG. 4. A sequence of scanning pulse signals are provided to gate lines of the liquid crystal display panel by a scanning driving unit, so as to turn on the TFT elements corresponding to each row of pixel units respectively. Square wave data signal are provided to data lines of the liquid crystal display panel by a data driving unit, and the pixel units connected with drains of the TFT elements are charged by the square wave data signals when the TFT elements are turned on. A first polarity reversing signal provided by a timing control unit reverses the polarity of said square wave data signals once after every 2n+1 scanning pulses, n being integer larger than or equal to 1. A second polarity reversing signal provided by a timing control unit is used for making the polarity of the square wave data signals of data lines corresponding to pixels in odd-numbered columns opposite to that corresponding to pixels in even-numbered columns at the same moment. The on/off state of TFT elements of pixel units in even-numbered columns are controlled by odd-numbered gate lines, and the on/off state of TFT elements of pixel units in odd-numbered columns are controlled by even-numbered gate lines.

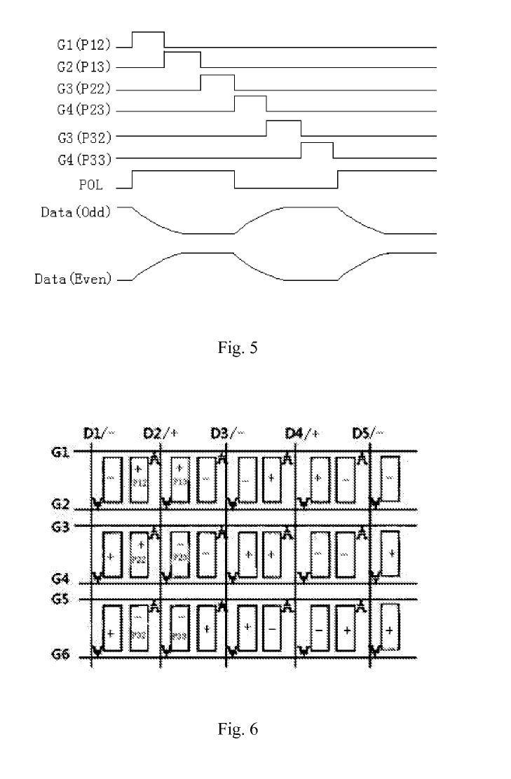

In one embodiment, the situation of n=1 is taken as an example, in this case, the polarity of said square wave data signal is reversed once after every three scanning pulses. FIG. 5 shows a timing diagram of a waveform of actual square wave data signals when their polarities are reversed once after every three scanning cycles selected according to the present disclosure, and corresponding scanning pulses.

As shown in FIG. 6, take the data line D2 as an example, the pixel units in the two sides of D2 are charged sequentially under the scanning pulses, and the pixel units P12, P13, P22, P23, P32, and P33 in the two sides of D2 are thereby driven in sequence. The polarity reversing result of the square wave data signals of data lines is indicated with signs “+” and “−” in FIG. 6.

As shown in FIG. 5 again, when a scanning pulse G1 arrives, the voltage of the signal on D2 does not reach a designated voltage, and consequently the even column of pixel unit P12 corresponding to D2 is undercharged during the scanning cycle of G1. When a scanning pulse of G3 arrives, the voltage of the signal of D2 reaches the designated voltage, and the even column of pixel unit P22 corresponding to D2 is charged completely during the scanning cycle of G3. When a scanning pulse of G2 between G1 and G3 arrives, the voltage of the signal of D2 is between the data signals voltage corresponding to the scanning signal of G1 and the data signals voltage corresponding to the scanning signal of G3, therefore, the charging level of the odd column of pixel unit P13 corresponding to D2 during the scanning cycle of G2 is between those of P12 and P22. Hence, the brightness relation of the pixel units in the two sides of the data line D2 is P12<P13<P22.

Then, a first polarity reversing signal provided by a timing control unit reverses the polarity of the data signals of D2, and the driving sequence of scanning pulses keeps unchanged. When a scanning pulse of G4 arrives, since the voltage of the signal of D2 does not reach a designated voltage, the odd column of pixel unit P23 corresponding to D2 is undercharged during the scanning cycle of G4. When a scanning signal of G6 arrives, since the voltage of the signal of D2 reaches the designated voltage, the odd column of pixel unit P33 corresponding to D2 is charged completely during the scanning cycle of G6. When a scanning signal of G5 between G4 and G6 arrives, the voltage of the signal of D2 is between the data signals voltage corresponding to the scanning signal of G4 and the data signals voltage corresponding to the scanning signal of G6, therefore, the charging level of the even column of pixel unit P32 corresponding to D2 during the scanning cycle of G5 is between those of P23 and P33. Hence, the brightness relation of the pixel units in the two sides of the data line D2 is P23<P32<P33.

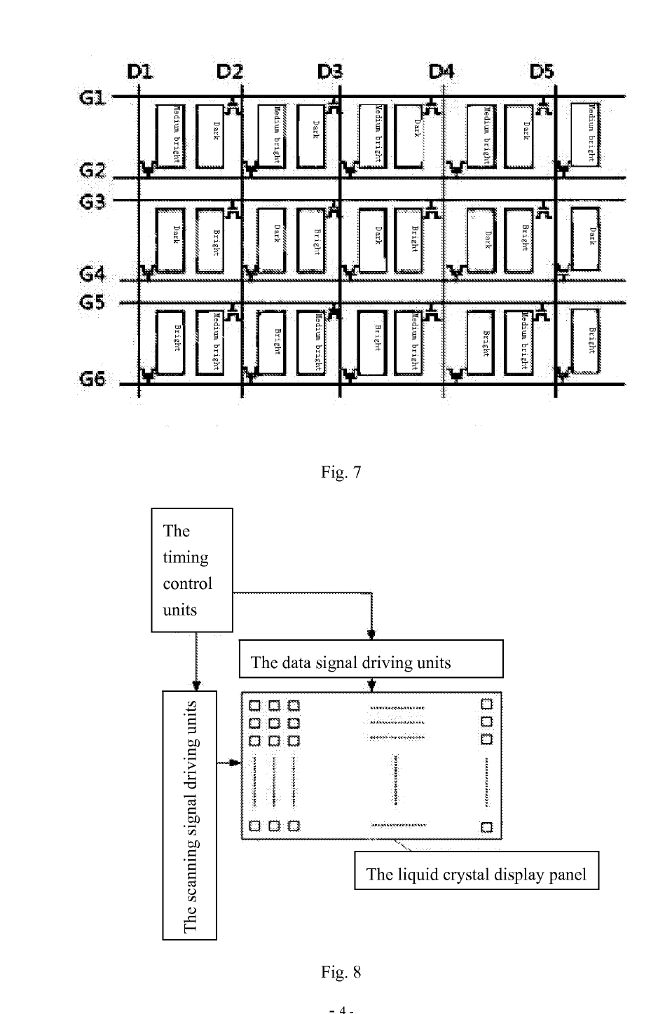

In this manner, the pixel units with different brightness are located in odd column an even column of the two sides of the data line D2 in a staggered way. Similarly, the pixel units with different brightness are located in the two sides of other data lines in a staggered way, so that pixel units with different brightness in space are arranged in a staggered way, thereby the display effect of bright-dark lines along vertical direction of a display panel being improved. The bright-dark relations of the pixel units of display panel are shown in FIG. 7, wherein “medium bright” means that the brightness thereof is between “bright” and “dark”.

As shown in FIG. 8, a HSD liquid crystal display device which is used for improving the display effect of bright-dark lines in vertical direction comprises the following components.

The device comprises a liquid crystal display unit. The liquid crystal display unit comprises a plurality pairs of gate lines and a plurality of data lines, wherein two pixel units are provided in the space surrounded by adjacent pairs of gate lines and adjacent date lines, and said data lines are connected with sources of TFT elements of pixel units in two adjacent columns respectively. The on/off state of said TFT elements of pixel units in even-numbered columns are controlled by odd-numbered gate lines, and the on/off state of said TFT elements of pixel units in odd-numbered columns are controlled by even-numbered gate lines.

A scanning signal driving unit is also included therein, for providing a sequence of scanning pulse signals to the gate lines, so as to turn on the TFT elements corresponding to each row of pixel units.

A data signal driving unit is further included therein, for providing a square wave data signals to the data lines. The square wave data signals are used for charging pixel units connected with drains of the TFT elements when the TFT elements are turned on.

The polarity of the square wave data signal is reversed once after every 2n+1 scanning pulses, in which n is integer larger than or equal to 1. That is to say, the polarity of the square wave data signal is reversed once after every odd number of scanning pulses.

The operation of the reverse can be controlled specially by a polarity reversing signal. In this case, the HSD liquid crystal display device may further comprise a timing control unit, which is used for providing the timing control signals to the scanning driving unit and the data driving unit. The provided timing control signals comprise two kinds of polarity reversing signals, a first polarity reversing signal reversing the polarity of said square wave data signal once every three scanning pulses, and a second polarity reversing signal enabling the polarity of a square wave data signal of data lines corresponding to pixel units in odd-numbered columns of the liquid crystal display panel is opposite to the polarity of a square wave data signals of data lines corresponding to pixel units in even-numbered columns of the liquid crystal display panel at the same moment. It should be noted that, the provided first polarity reversing signal may not reverse the polarity of the square wave data signal once every 3 scanning pulses necessarily. In fact, as aforementioned, a polarity reversing control signal can be provided to the data driving unit by the timing control unit every 2n+1 scanning pulses, n being integer larger than or equal to 1. In this manner, the polarity of the square wave data signal is reversed once every odd number of scanning pulses, thereby the phenomena of uneven brightness in the display panel being eliminated. However, n shall not be a large number so as to ensure the display effect. Otherwise, this would cause the problems like that occurs in the case of direct current driving.

It could be understood that, the embodiments disclosed herein are not limited by the specific structures, processing steps or materials disclosed herein, but incorporate the equivalent substitutes of these features which are comprehensible to a person skilled in the art. It could be also understood that, the terms used herein are for describing the specific embodiments, not for limiting them.

The phrases “one embodiment” or “embodiments” referred to herein mean that the descriptions of specific features, structures and characteristics in combination with the embodiments are included in at least one embodiment of the present disclosure. Therefore, the phrases “one embodiment” or “embodiments” appeared in different parts of the whole description do not necessarily refer to the same embodiment.

To achieve the purpose of convenience, a plurality of items, structural units, component units and/or materials used herein can be listed in a common list. However, the list shall be understood in a way that each element thereof represents an only and unique member. Therefore, when there are not other explanations, none of members of the list can be understood as an actual equivalent of other members in the same list only based on the fact that they appear in the same list. In addition, the embodiments and examples of the present disclosure can be explained with reference to the substitutes of each of the components. It could be understood that, the embodiments, examples and substitutes herein shall not be interpreted as the equivalents of one another, but shall be considered as separate and independent representatives of the present disclosure.

In addition, the features, structures and characteristics described herein can be combined with one another in any other suitable way in one embodiment or a plurality of embodiments. The specific details, such as lengths, widths and shapes, described herein are for providing a comprehensive understanding of the embodiments of the present disclosure. However, it is understandable for a person skilled in the art that, the present disclosure may be implemented in other ways different from the specific details specified herein, or may be implemented in other methods, components and materials. The structures, materials and operations known to all are not shown or described in the examples to avoid blurring various aspects of the present disclosure.

The embodiments are described hereinabove to interpret the principles of the present disclosure in one application or a plurality of applications. However, a person skilled in the art, without departing from the principles and thoughts of the present disclosure, can make various modifications to the forms, usages and details of the embodiments of the present disclosure without any creative work. Therefore, the protection scope of the present disclosure shall be determined by the claims.

1. A method for driving a HSD liquid crystal display panel, comprising the steps of:
providing a sequence of scanning pulse signals to gate lines of said liquid crystal display panel to turn on TFT elements corresponding to each row of pixel units respectively; and
providing square wave data signals to data lines of said liquid crystal display panel to charge pixel units connected with drains of said TFT elements through said square wave data signals when said TFT elements are turned on, wherein the polarity of said square wave data signal is reversed once every 2n+1 scanning pulses, in which n is integer larger than or equal to 1.

2. The method according to claim 1, wherein the polarity of said square wave data signal is controlled through a first polarity reversing signal provided by a timing control unit, and is reversed once every three scanning pulses.

3. The method according to claim 1, wherein the on/off state of said TFT elements of pixel units in even-numbered columns are controlled by odd-numbered gate lines, and the on/off state of said TFT elements of pixel units in odd-numbered columns are controlled by even-numbered gate lines.

4. The method according to claim 2, wherein a second polarity reversing signal is provided by the timing control unit so that the polarity of said square wave data signals of data lines corresponding to pixels in odd-numbered columns is opposite to the polarity of said square wave data signals of data lines corresponding to pixels in even-numbered columns at the same time.

5. A HSD liquid crystal display device, comprising:
a liquid crystal display unit comprising a plurality pairs of gate lines and a plurality of data lines, wherein two pixel units are provided in the space surrounded by adjacent pairs of gate lines and adjacent date lines, and said data lines are connected with sources of TFT elements of pixel units in two adjacent columns respectively;
a scanning signal driving unit for providing sequence scanning pulse signals to said gate lines, thus turning on said TFT elements corresponding to each row of pixel units; and
a data signal driving unit for providing a square wave data signals to said data lines, thus charging pixel units connected with drains of said TFT elements by said square wave data signals when said TFT elements are turned on, wherein the polarity of said square wave data signal is reversed once every 2n+1 scanning pulses, in which n is integer larger than or equal to 1.

6. The liquid crystal display device according to claim 5, wherein said device further comprises a timing control unit for proving a first polarity reversing signal to said data signal driving unit, so that the polarity of said square wave data signal is reversed once every three scanning cycles.

7. The liquid crystal display device according to claim 6, wherein a second polarity reversing signal is provided by the timing control unit so that the polarity of said square wave data signals of data lines corresponding to pixels in odd-numbered columns is opposite to the polarity of said square wave data signals of data lines corresponding to pixels in even-numbered columns at the same time.

8. The liquid crystal display device according to claim 6, wherein the gate lines of said device are arranged as follows: the on/off state of said TFT elements of pixel units in even-numbered columns are controlled by odd-numbered gate lines, and the on/off state of said TFT elements of pixel units in odd-numbered columns are controlled by even-numbered gate lines.
